(19) United States
(12) Patent Application Publication
(10) Pub. No.: US 2006/0230233 A1
(43) Pub. Date: Oct. 12, 2006

(54) Technique for allocating cache line ownership

(76) Inventors: Simon C. Steely JR., Hudson, NH (US); Stephen R. Van Doren, Northborough, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/104,197

(22) Filed: Apr. 11, 2005

(51) Int. Cl. G06F 12/00

(52) U.S. Cl. 711/130

(57) ABSTRACT

A technique to share cache lines among a plurality of bus agents. Embodiments of the invention comprise at least one technique to allow a number of agents, such as a processor or software program being executed by a processor, within a computer system or computer network to transfer ownership of a locked (“owned”) cache line, under certain circumstances, without incurring as much of the operational overhead and resulting performance degradation of many prior art techniques.

### FIELD OF INVENTION

Embodiments of the invention described herein relate to cache memory. More particularly, embodiments of the invention relate to a technique for sharing a locked cache line among one or more agents within a computer system or network in a fair manner.

### BACKGROUND

Typical prior art caching schemes allow critical programs and bus agents within computer systems to access lines of cache that are locked or “owned” by another program or agent using techniques involving significant overhead in terms of processing operations and time. Furthermore, prior art caching schemes typically require even more overhead in order to return ownership to the original or other owner once the critical program or agent has used the data from the cache line. Moreover, prior art cache line sharing techniques do not typically take into account which agents or programs have already had an opportunity to own the cache line when determining whether to return the cache line to its original owner or some other agent or program in the system. Accordingly, prior art cache line sharing techniques can be “unfair”, as they may result in one agent or programming gaining ownership of a cache line more than others.

For example, in one prior art cache line sharing technique, ownership is transferred to other programs or agents within a system according to which agent or program has most recently requested ownership. In this example, a program or agent could gain ownership of a cache line multiple times before other agents or programs have been granted ownership once. Furthermore, in some prior art cache line sharing techniques, numerous bus cycles may be needed for a program or agent requesting ownership of the cache line to signal its request to the original owner and for the original owner to communicate ownership back to the requesting agent or program. The problem is exacerbated when there are a number of requesting agents each waiting for ownership of a particular locked cache line, which can result in greater system performance degradation.

### BRIEF DESCRIPTION OF THE DRAWINGS

Claimed subject matter is particularly and distinctly pointed out in the concluding portion of the specification. The claimed subject matter, however, both as to organization and method of operation, together with objects, features, and advantages thereof, may best be understood by reference to the following detailed description when read with the accompanying drawings in which:

FIG. 1 illustrates an arrangement of bus agents in which at least one embodiment of the invention may be used.

FIG. 2 illustrates a cache line description buffer in which information may be stored useful in one embodiment of the invention.

FIG. 3 illustrates a point-to-point (PtP) network of bus agents in which at least one embodiment of the invention may be used.

FIG. 4 is a flow diagram illustrating operations that may be used in at least one embodiment of the invention.

FIG. 5 illustrates two bit vectors that may be used in conjunction with at least one embodiment of the invention to indicate which bus agents are waiting for ownership of a cache line and which have been granted ownership of a cache line.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

Embodiments of the invention comprise at least one technique to allow a number of agents, such as a processor or software program being executed by a processor, within a computer system or computer network to access a locked (“owned”) cache line, under certain circumstances, without incurring as much of the operational overhead and resulting performance degradation of many prior art techniques. Furthermore, embodiments of the invention comprise at least one technique to allow such agents to gain ownership of the cache line in substantially fair manner. In at least one embodiment, a locked cache line has associated therewith a vector or vectors of at least two bits, each vector(s) to indicate whether an agent or program (hereafter “agent”) having access to the locked cache line is waiting and/or has been granted ownership of the cache line, respectively. In at least one embodiment, the two bit vectors are included in a cache line description buffer corresponding to the locked cache line, and the two bit vectors can migrate with the ownership of the cache line to other agents.

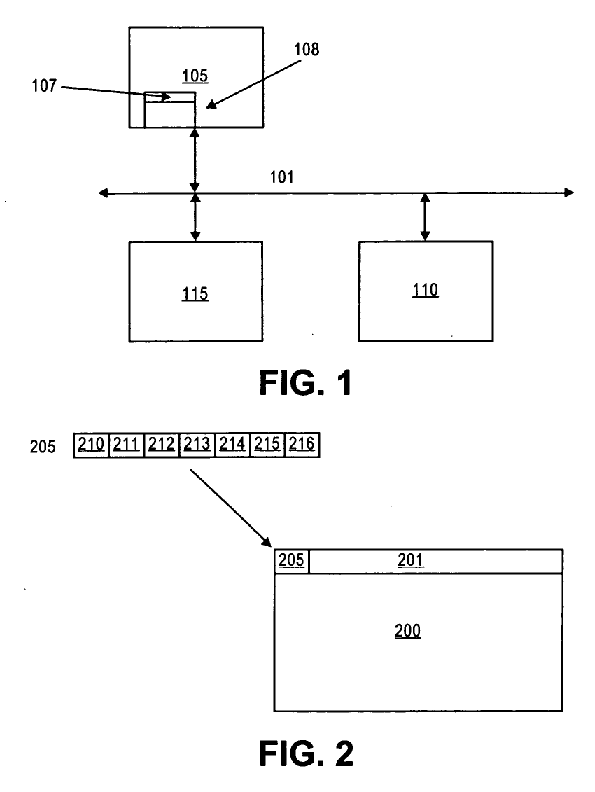

FIG. 1 illustrates an arrangement of bus agents in which at least one embodiment of the invention may be used. Particularly, FIG. 1 illustrates a bus 101 over which a number of bus agents communicate. In one embodiment, the processor “A” 105 has locked, or “owns”, cache line 107 in cache 108, whereas graphics device 110 and processor “B” 115 may attempt to access the locked cache line. Processor A may have acquired ownership of the cache line through executing an instruction, such as a “lock-acquire” instruction, which places the line in a state that allows other bus agents to access the line without resorting to the operational overhead of various prior art techniques.

In at least one embodiment of the invention, the agent that owns the cache line may transition ownership of the cache line to other agents that are waiting to gain ownership of the cache line. However, unlike in some prior art techniques, embodiments of the invention facilitate an allocation of ownership of the cache line according to an algorithm that allows agents that have not received ownership of the cache line to receive ownership of the cache line before others that have already received ownership of the cache line. Furthermore, embodiments of the invention help to reduce communication traffic on an interconnect between the bus agent currently owning the cache line and other agents waiting for ownership of the cache line.

In order for an agent owning the locked cache line of FIG. 1 to determine the next agent that should receive ownership of the locked cache line, at least one embodiment has associated with the cache line, a grant vector of bits to indicate which agents within the system have already received ownership of the locked cache line and a wait vector of bits to indicate which ones are waiting to receive ownership of the locked cache line. For example, in one embodiment the description buffer associated with the locked cache line contains two bit vectors that contain as many entries as there are agents in the system to gain ownership of the locked cache line. In such an embodiment, a grant vector entry contains a bit to indicate whether a particular agent has been granted ownership of the cache line, and a wait bit vector entry contains a bit to indicate whether it is also waiting for ownership of the cache line. An agent may have been granted ownership of the cache line, as indicated by its “grant” bit being set in the grant vector entry, and is once again requesting ownership, as indicated by its “waiting” bit being set in the wait vector entry. Alternatively, an agent may be waiting for ownership of the cache line, as indicated by its “waiting” bit being set in the corresponding wait vector entry, and has not been granted ownership of the cache line before any other agent, as indicated by the “grant” bit not being set in the grant vector entry. The polarity of the waiting and grant bits may be different to indicate different states in other embodiments.

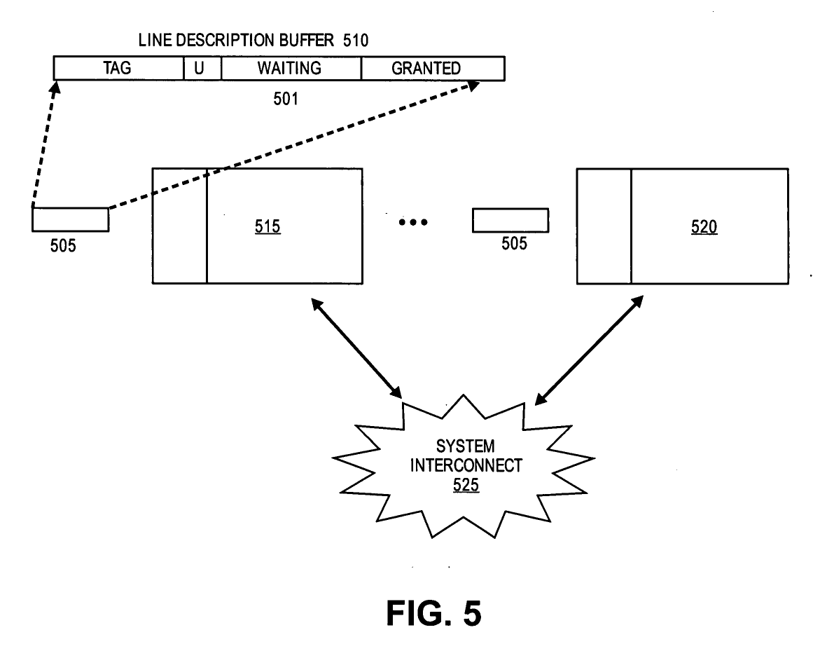

FIG. 5 illustrates two bit vectors, according to one embodiment, that may be stored in a cache line description buffer, or otherwise associated with a locked cache line. Each vector 501 510 stored in the description buffer 505 contains as many entries as there are agents within a computer system that may own the cache line to which the vectors correspond. The wait vector, 501 contains bits (“wait bits”) to indicate whether each agent that may own the cache line is currently waiting for ownership of the cache line, and the grant vector 510 contains bits (“grant bits”) to indicate whether each agent that may own the cache line has previously been granted the cache line before all other waiting agents have received ownership of the cache line. In one embodiment of the invention, the contents of the two bit vectors are transferred along with cache line ownership from an agent 515 currently owning the cache line to which the vectors correspond to a waiting agent 520 that is determined to be an appropriate owner of the cache line according to the criteria mentioned below across some interconnect network 525.

In one embodiment, ownership of the cache line is granted only to those agents who have not previously been granted ownership of the cache line before all other requesting agents have been granted ownership the cache line, as indicated by the grant bit not being set, and who are requesting ownership of the cache line, as indicated by the waiting bit being set. If an agent is waiting for ownership of the cache line, but has already received ownership before the other agents in the two bit vectors have received ownership, then ownership is not granted to that agent by the current owner. In one embodiment, after all waiting agents (those with their waiting bit set in the grant vector) have been granted ownership of the cache line (indicated by the grant bit being set), the grant bits of all agents are cleared and the selection process may start again.

FIG. 2 illustrates a cache line descriptor buffer containing various cache line descriptor entries that may exist or otherwise be associated with a locked cache line and/or a cache line containing an uncached copy of the locked cache line, according to one embodiment of the invention. Associated with each line 201 of cache 200 is a cache line buffer 205 that contains various cache line descriptor entries 210-215. In one embodiment, the cache line descriptor entries include a tag 210 to indicate an address to which the cache line corresponds, a state entry 211 to indicate, among other things, whether the line is in a locked state that may be accessed by other agents seeking an uncached copy or whether the line is an uncached copy, as well as various pointers 212-215 to indicate other bus agents that may have uncached copies of the cache line. Although in the embodiment illustrated in FIG. 2 the cache line description buffer contains 4 pointers, more or fewer pointers may be used in other embodiments of the invention.

Cache line descriptor buffer 205 may also contain bit vector(s) 216 to indicate which agents in the system to which the cache corresponds are waiting for ownership of the cache line 201 and which ones have been granted ownership of the cache line 201 before all other waiting agents have been granted ownership of cache line 201. In other embodiments, descriptor buffer entry 216 may contain two bit vectors to indicate which agents are waiting for the cache line and which ones have been granted the cache line. In one embodiment, the information stored in the two bit vectors 216 is transferred along with the ownership of the cache line 201 to other agents, such that each agent that owns the cache line 201 may examine the two bit vectors and determine which agent should next receive ownership of the cache line 201.

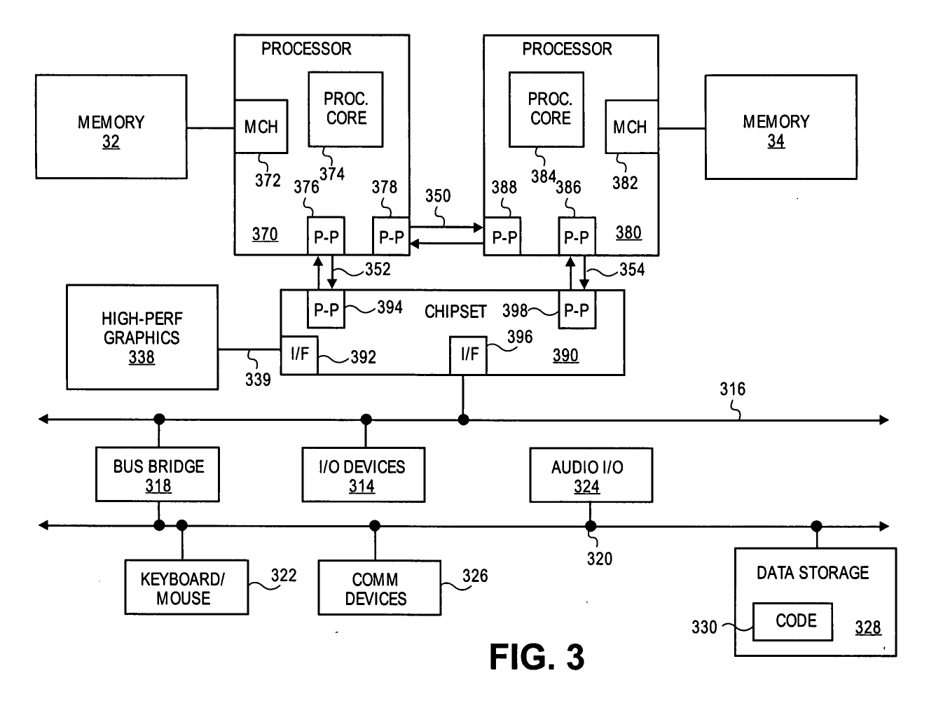

FIG. 3 illustrates a computer system that is arranged in a point-to-point (PtP) configuration. In particular, FIG. 3 shows a system where processors, memory, and input/output devices are interconnected by a number of point-to-point interfaces.

The system of FIG. 3 may also include several processors, of which only two, processors 370, 380 are shown for clarity. Processors 370, 380 may each include a local memory controller hub (MCH) 372, 382 to connect with memory 22, 24. Processors 370, 380 may exchange data via a point-to-point (PtP) interface 350 using PtP interface circuits 378, 388. Processors 370, 380 may each exchange data with a chipset 390 via individual PtP interfaces 352, 354 using point to point interface circuits 376, 394, 386, 398. Chipset 390 may also exchange data with a high-performance graphics circuit 338 via a high-performance graphics interface 339.

At least one embodiment of the invention may be located within the PtP interface circuits within each of the PtP bus agents of FIG. 3. Other embodiments of the invention, however, may exist in other circuits, logic units, or devices within the system of FIG. 3. Furthermore, other embodiments of the invention may be distributed throughout several circuits, logic units, or devices illustrated in FIG. 3.

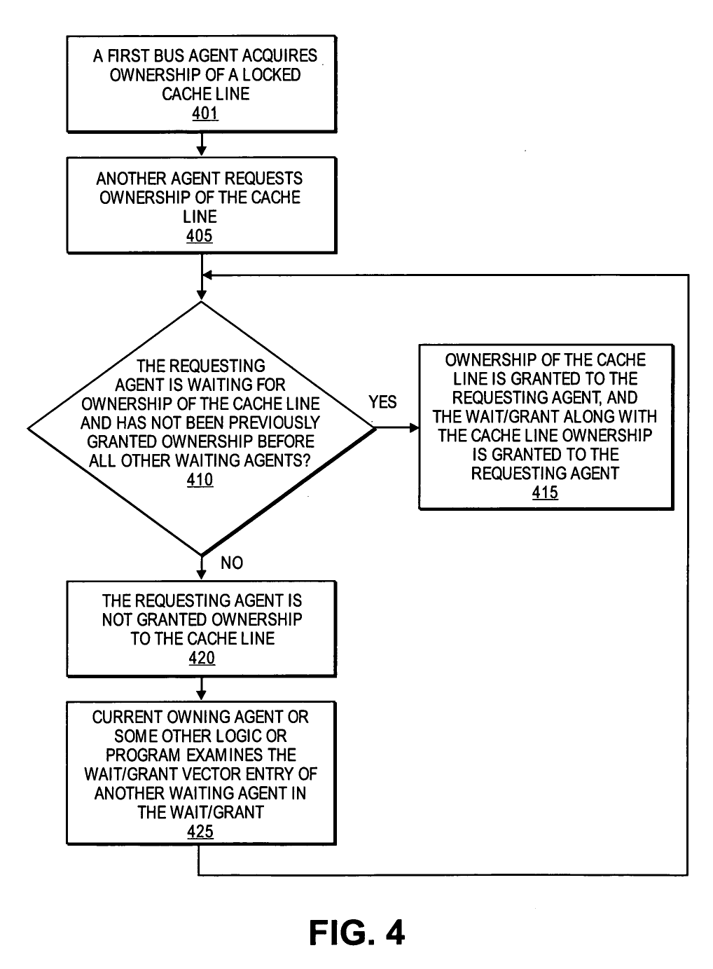

FIG. 4 is a flow diagram illustrating operations used in conjunction with at least one embodiment of the invention. Specifically, FIG. 4 illustrates operations performed in placing a cached line in a locked state, accessing the locked line, and transitioning ownership of the locked line, according to one embodiment of the invention. At operation 401, a first bus agent acquires ownership of a locked cache line and at operation 405 another agent requests ownership of the cache line. At operation 410, the first bus agent or some other logic or program, which has access to two bit vectors indicating which agents are waiting for ownership and which agents have been granted ownership of the cache line, determines whether the requesting agent is waiting for ownership of the cache line, by virtue of the “waiting” bit of the wait vector entry corresponding to the requesting agent being set, and whether the requesting agent has been granted ownership of the cache line before all other requesting agents (those with their “waiting” bit set) have been granted ownership of the cache line, by virtue of the “granted” bit of the grant vector entry corresponding to the requesting agent being set.

If the requesting agent is currently waiting for ownership of the cache line and has not been previously granted ownership of the cache line before all other requesting agents have been granted ownership of the cache line, then at operation 415, ownership of the cache line is granted to the requesting agent, and the two bit vectors along with the cache line ownership is transferred to the requesting agent. Otherwise, if the requesting agent is waiting for ownership of the cache line but has previously been granted ownership of the cache line before all other requesting agents have been granted ownership of the cache line, then at operation 420, the requesting agent is not granted ownership to the cache line and the current owning agent or some other logic or program examines the two bit vectors' entry of another waiting agent in the two bit vectors at operation 425, and the process returns to operation 410. The other waiting agent whose wait and grant bits are examined may correspond to the next sequential entry in the two bit buffer, in one embodiment, whereas in other embodiments, the other waiting agent may be chosen according to some algorithm that may not choose the next sequential waiting agent whose wait and grant bits are in the two bit vectors.

After ownership and the two bit vectors of a cache line is transferred from one agent to another, according to one embodiment, a signal may be sent from the agent owning the cache line or from some other logic or program to the rest of the agents waiting to receive ownership that invalidates each of their respective copies of the cache line and resets the wait bits in each of their line description buffers corresponding to the cache line to a state indicating that none are currently waiting to receive ownership of the cache line. The agents that wish to receive ownership of the cache line may then indicate to the current owner of the cache line to reassert the wait bit corresponding to the signaling agent. Alternatively, in one embodiment, only those agents who do not have the grant bit set for the cache line may receive a signal to invalidate the cache line and reset the wait bit, which preserves the two bit vectors' state of the cache line for those agents that have previously been granted ownership of the cache line before all other agents waiting for ownership of the cache line.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
placing a cache line into a locked state;
transferring ownership of the cache line to the at least one other bus agent along with a first indicator of other agents waiting for ownership of the cache line.

2. The method of claim 1 wherein the first indicator comprises a vector having a number of entries equal to a number of bus agents to gain ownership of the cache line.

3. The method of claim 2 wherein the vector comprises a first entry corresponding to the at least one other bus agent.

4. The method of claim 3 wherein the first entry comprises a second indicator of whether the at least one other bus agent is waiting for ownership of the cache line and whether the at least one other bus agent has been granted ownership of the cache line.

5. The method of claim 4 wherein the second indicator comprises a first bit field to indicate whether the at least one other bus agent is waiting for ownership of the cache line and second bit field to indicate whether the at least one other bus agent has been granted ownership of the cache line.

6. The method of claim 5 wherein the first bit field comprises only one bit and wherein the second bit field comprises only one bit.

7. The method of claim 1 wherein ownership of the cache line is transferred to the at least one other bus agent only if the at least one other bus agent is waiting for ownership of the cache line and the at least one other bus agent has not been granted ownership of the cache line before all other bus agents waiting for ownership of the cache line.

8. An apparatus comprising:
a cache line description buffer corresponding to a first bus agent to own the cache line, the cache line description buffer including a first field to indicate what other requesting bus agents are waiting for ownership of the cache line and which of the other requesting bus agents have been granted ownership of the cache line, wherein the first field is to migrate with the ownership of the cache line to at least one of the other requesting bus agents.

9. The apparatus of claim 8 wherein the first field comprises a vector having a number of entries equal to the number of other requesting bus agents.

10. The apparatus of claim 9 wherein each entry comprises a waiting bit to indicate whether a corresponding bus agent is waiting for ownership of the cache line and a granted bit to indicate whether the corresponding bus agent has been granted ownership of the cache line.

11. The apparatus of claim 10 wherein ownership of the cache line is to be granted to the at least one other requesting bus agent if the at least one other requesting bus agent is waiting for ownership of the cache line and if the at least one other requesting bus agent has not been granted ownership of the cache line before all other waiting bus agents.

12. The apparatus of claim 11 wherein if the at least one other requesting bus agent is not waiting for ownership of the cache line or the at least one other requesting bus agent has been granted ownership of the cache line before all other waiting bus agents, ownership of the cache line is granted to another bus agent waiting for ownership that has not been granted ownership of the cache line before all other waiting bus agents.

13. The apparatus of claim 12 wherein the wait bit is cleared after the ownership of the cache line is transferred.

14. The apparatus of claim 10 wherein if ownership of the cache line is transferred to another bus agent, each waiting bus agent is to receive a signal to invalidate a corresponding cache line and the wait bit is to be cleared.

15. The apparatus of claim 10 wherein if ownership of the cache line is transferred, only waiting bus agents not having their granted bit set are to receive a signal to invalidate a corresponding cache line and the wait bit is to be cleared.

16. A system comprising:
a first bus agent comprising two bit vectors to indicate which other bus agents are waiting for ownership of a cache line and which other bus agents have been granted ownership of the cache line;
a second bus agent to receive the contents of the two bit vectors if ownership of the cache line is transferred to the second bus agent.

17. The system of claim 16 wherein the vectors have a number of entries equal to a number of bus agents that are waiting to receive ownership of the cache line.

18. The system of claim 17 wherein each entry comprises a wait bit and a grant bit.

19. The system of claim 18 wherein if the wait bit of the second bus agent is set to a one and the grant bit of the second bus agent is set to a zero, the second bus agent is to receive ownership of the cache line along with the contents of the two bit vectors.

20. The system of claim 19 wherein if the wait bit of the second bus agent is set to zero or the wait bit of the second bus agent is set to one and the grant bit of the second bus agent is set to one, then the second bus agent will not receive ownership of the cache line.

21. The system of claim 20 wherein if ownership of the cache line is transferred to the second bus agent, all other agents having their wait bit set to one are to receive an invalidate signal and their wait bit is set to zero.

22. The system of claim 20 wherein if ownership of the cache line is transferred to the second bus agent, only bus agents having their wait bit set to one and having their grant bit set to zero are to receive an invalidate signal and are to have their wait bit set to zero.

23. The system of claim 20 wherein the first and second bus agents are microprocessors.

24. The system of claim 20 wherein one or both of the first and second bus agents are a computer program.

25. A machine-readable medium having stored thereon a set of instructions, which if executed by a machine cause the machine to perform a method comprising:
placing a cache line into a locked state;
transferring ownership of the cache line to the at least one other bus agent along with a first indicator of other agents waiting for ownership of the cache line, wherein the first indicator comprises a vector having a first entry corresponding to the at least one other bus agent.

26. The machine-readable medium of claim 25 wherein the first entry comprises a second indicator of whether the at least one other bus agent is waiting for ownership of the cache line and whether the at least one other bus agent has been granted ownership of the cache line.

27. The machine-readable medium of claim 26 wherein the first bit field comprises a wait bit and wherein the second bit field comprises a grant bit.

28. The machine-readable medium of claim 27 wherein the wait bit is cleared after the ownership of the cache line is transferred.

29. The machine-readable medium of claim 28 wherein if ownership of the cache line is transferred to another bus agent, each waiting bus agent is to receive a signal to invalidate a corresponding cache line and the wait bit is to be cleared.

30. The machine-readable medium of claim 29 wherein if ownership of the cache line is transferred, only waiting bus agents not having their granted bit set are to receive a signal to invalidate a corresponding cache line and the wait bit is to be cleared.
